(19) United States
(12) Patent Application Publication
(10) Pub. No.: US 2025/0229442 A1
(43) Pub. Date: Jul. 17, 2025

(54) SYSTEMS AND METHODS FOR A ROBOTIC ARM

(71) Applicant: Center Point Bio-Tech, LLC, Las Vegas, NV (US)

(72) Inventor: Tim BAUM, Las Vegas, NV (US)

(21) Appl. No.: 18/979,238

(22) Filed: Dec. 12, 2024

Related U.S. Application Data
(60) Provisional application No. 63/620,569, filed on Jan. 12, 2024.

(51) Int. Cl. B25J 18/04; B25J 13/08; B25J 15/00

(52) U.S. Cl. CPC B25J 18/04; B25J 13/087; B25J 15/0033

(57) ABSTRACT

A robotic assembly associated with gripping an object may determine, using an angle sensor, a relative position of a first gripping arm in relation to a second gripping arm of a robotic assembly. The robotic assembly may separate, using an actuator, the first gripping arm and the second gripping arm of the robotic assembly. The robotic assembly may position the gripping arms around an object, so the first gripping arm and second gripping arm accommodate the object. The robotic assembly may then join the first gripping arm and the second gripping arm until the first roller, second roller, and third roller are in contact with the object. The robotic assembly may apply pressure to the object using a plurality of compression springs between the first gripping arm and second gripping arm allowing the robotic assembly to grip the object.

### CROSS-REFERENCE TO RELATED APPLICATIONS

This application claims the benefit of, and priority to, U.S. Provisional Patent Application No. 63/620,569, filed Jan. 12, 2024, entitled “Rapid Diagnostic Testing,” the disclosure of which is incorporated by reference in its entirety.

### TECHNICAL FIELD

The present systems and processes relate generally to a robotic arm and more particularly to a robotic arm for handling and transporting diagnostic samples.

### BACKGROUND

Medical diagnostics play a crucial role in healthcare by enabling the detection, diagnosis, and monitoring of diseases. Diagnostic tests involve the examination of biological samples such as blood, tissue, or urine to identify disease markers. The accuracy of these tests is critical, as they directly influence treatment decisions and patient outcomes.

Despite advancements in diagnostic techniques, several challenges persist in traditional diagnostic testing methods. Primary among these is the risk of sample contamination, which can occur at multiple points during the handling process. Such contamination can lead to inaccurate test results, potentially resulting in misdiagnosis or inappropriate treatment. Moreover, conventional testing methods often involve manual processes prone to human error and operational inefficiencies. These inefficiencies can lead to delays in diagnosis and increased healthcare costs.

Additionally, increasing volume of diagnostic tests demanded by modern healthcare systems puts further strain on laboratory operations, highlighting the need for more efficient and reliable testing processes. The shortcomings of current diagnostic practices underscore a significant need for innovation in how diagnostic samples are handled and processed.

This background information is provided to reveal information believed by the applicant to be of possible relevance. No admission is necessarily intended, nor should be construed, that any of the preceding information constitutes prior art.

### BRIEF SUMMARY OF THE DISCLOSURE

Briefly described, and in various aspects, the present disclosure generally relates to systems, devices, and apparatuses for a robotic assembly, particularly to a robotic arm for handling and transporting diagnostic samples. According to some aspects, a robotic arm may include a gripping mechanism for handling diagnostic samples. The gripping mechanism may securely grip and manipulate diagnostic samples of various sizes and shapes, while maintaining a simple and cost-effective design. Moreover, the robotic arm may operate within an automated diagnostic system, mitigating the risk of contamination and/or enhancing overall performance and utility.

According to some aspects, the robotic arm may include a first gripping arm that is defined by a first length. The first gripping arm may have a first roller located at a first distal end of the gripping arm, and a second roller positioned at another location along the first gripping arm. The robotic assembly may further include a second gripping arm defined by a second length that is less than the first length of the first gripping arm. The second gripping arm may include a third roller mounted at a first distal end of the second gripping arm. A second distal end of the first gripping arm may be pivotally connected about a first axis to a second distal end of the second gripping arm.

According to some aspects, the robotic arm may include a plurality of compression springs that provide tension between the first gripping arm and the second gripping arm. An actuator attached to the first gripping arm and to the second gripping arm may counteract the tension provided by the compression springs by extending from a first length to a second length. The actuator may be a linear actuator that extends linearly between the first and second lengths. The linear actuator may increase and decrease the angle of the pivotal connection between the first and second gripping arms. The gripping arms may separate to accommodate the object when the actuator extends to the second length. The actuator may allow the gripping arms to accommodate objects of various sizes.

According to some aspects, the robotic arm may include an anti-backlash spring. The anti-backlash spring may maintain an angular position of the first gripping arm in relation to the second gripping arm when the robotic arm grips the object. Moreover, the robotic assembly may further include an angle sensor. The angle sensor may determine the relative position of the first gripping arm in relation to the second gripping arm. Each of the first roller, the second roller, and the third roller may contact the object based on the tension provided by the compression springs. The rollers may be positioned to align with a centroidal axis of the object when gripped. The position of the rollers facilitates aligning an object within the first and second gripping arms.

According to some aspects, an apparatus including the robotic arm may include a motor. The motor may rotate the robotic arm about a second axis perpendicular to the first axis, e.g., enabling the robotic assembly to reach objects in various locations within a diagnostic system. The motor and the angle sensor may be operated by a controller in electronic communication with the angle sensor and the motor. The controller may synchronize movement of the robotic arm based on inputs from the angle sensor and control signals to the motor.

According to some aspects, the apparatus may include a container with slots. Each slot may be defined by dimensions associated with an object. The robotic arm may move an object into a slot. The apparatus can further include a drawer for receiving and supporting an object.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE FIGURES

Reference will now be made to the accompanying drawings, which are not necessarily drawn to scale.

FIG. 1A illustrates an exemplary robotic assembly according to various aspects of the present disclosure;

FIG. 1B illustrates a first gripping arm and a second gripping arm according to various aspects of the present disclosure;

FIG. 1C illustrates a pivotal connection between the first gripping arm and the second gripping arm according to various aspects of the present disclosure;

FIG. 2 illustrates an exemplary hotel assembly according to various aspects of the present disclosure;

FIG. 3 illustrates an exemplary diagnostic system according to various aspects of the present disclosure;

FIG. 4 illustrates an exemplary diagnostic system according to various aspects of the present disclosure;

FIG. 5 illustrates an exemplary exterior of a diagnostic system according to various aspects of the present disclosure;

FIG. 6 illustrates an exemplary process performed by a diagnostic system according to various aspects of the present disclosure;

FIG. 7 illustrates an exemplary diagrammatic representation of a machine in the form of a computer system according to various aspects of the present disclosure; and

FIG. 8 illustrates a schematic of an exemplary device according to various aspects of the present disclosure.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

The embodiments described herein are not limited in application to the details set forth in the following description or illustrated in the drawings. The disclosed subject matter is capable of other embodiments and of being practiced or carried out in various ways. Also, the phraseology and terminology used herein is for the purpose of description and should not be regarded as limiting. The use of “including,” “comprising,” or “having” and variations thereof herein is meant to encompass the items listed thereafter, additional items, and equivalents thereof. The terms “connected” and “coupled” are used broadly and encompass both direct and indirect connections and couplings. In addition, the terms “connected” and “coupled” are not limited to electrical, physical, or mechanical connections or couplings. As used herein, the terms “machine,” “computer,” “server,” and “work station” are not limited to a device with a single processor, but may encompass multiple devices (e.g., computers) linked in a system, devices with multiple processors, special purpose devices, devices with various peripherals and input and output devices, software acting as a computer or server, and combinations of the above.

The present disclosure includes a robotic arm for use in a diagnostic device. The robotic arm may be used to pick up and move objects such as petri dishes containing diagnostic samples. The robotic arm may include several components and features that enable efficient and reliable handling of diagnostic samples with precision and care.

According to some aspects, the robotic arm may include a gripping mechanism capable of adjusting to different sizes and shapes of petri dishes (e.g., depending on the type of sample and the diagnostic test being conducted). For example, the robotic arm may include articulating members that can gently yet securely grasp the dishes without risking contamination or damage to the samples contained within. Additionally, the robotic arm may include sensors that provide real-time feedback on the position and orientation of the robotic arm, its respective members, and/or the object being handled by the robotic arm. The robotic arm may, based on information received from the sensors and transmitted to one or more motors, precisely and accurately place diagnostic samples into a diagnostic device for analysis. For example, angle sensors and proximity sensors may be used by the robotic arm to maintain the correct alignment and distance from or with one or more elements of the diagnostic device, e.g., minimizing any risk of accidental collisions or misplacements that could compromise the integrity of the diagnostic sample.

One or more operations of the robotic arm may incorporate may be programmed to execute complex sequences of movements and/or automation. The movements and/or automation may be facilitated by an integrated control system that uses algorithms to optimize the path and actions of the arm, reducing the time it takes to process samples and increasing the throughput of the diagnostic device. By automating the sample handling process, the robotic arm may reduce human intervention, a significant factor in minimizing contamination risks.

Moreover, the robotic arm may comprise robust construction materials and/or surfaces that are easily cleaned and disinfected, enhancing sterility in testing environments. For example, one or more surfaces of the robotic arm may be constructed from materials that resist corrosion and can withstand repeated exposure to cleaning agents and disinfectants. According to some aspects, reliability of the robotic arm may be supported by one or more redundancies. For instance, if one sensor fails, another sensor may take over without interrupting the operation of the robotic arm and allowing the robotic arm to operate continuously in a high-throughput environment, where downtime can lead to significant delays in diagnostic results.

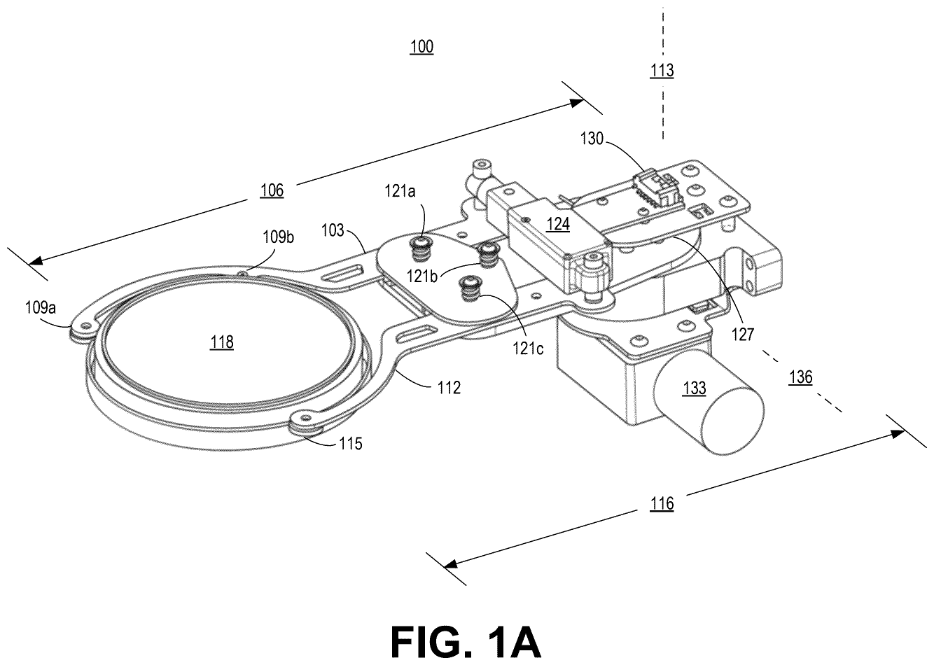

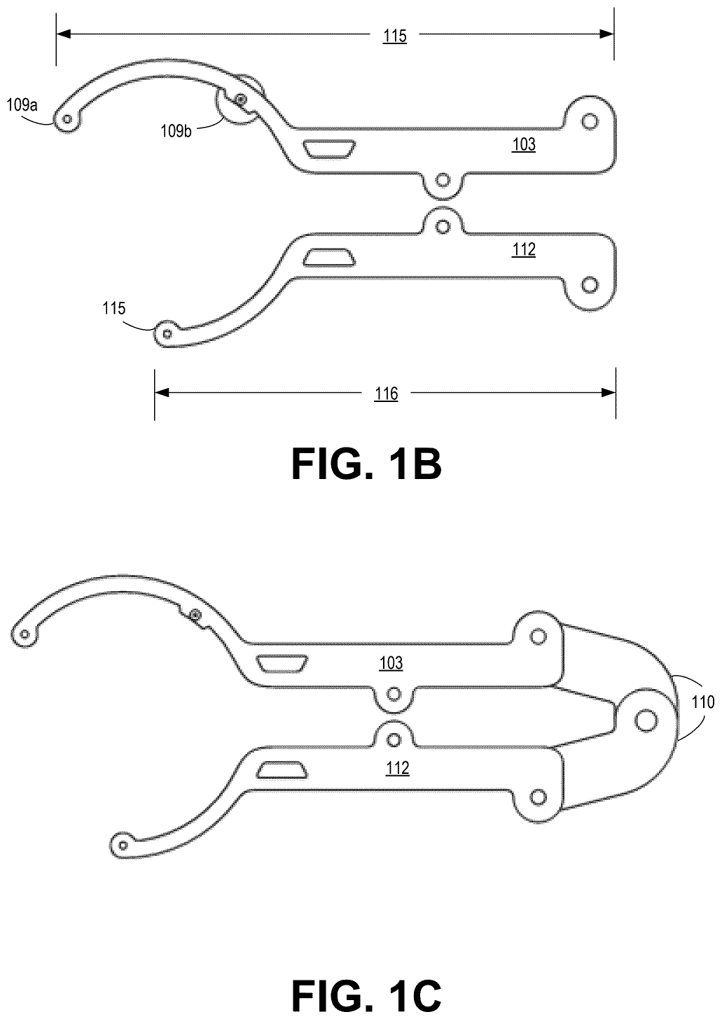

Turning now to the drawings, exemplary embodiments are described in detail. With reference to FIG. 1A, shown is a robotic assembly 100 according to various aspects of the present disclosure. The robotic assembly 100 may be configured to handle diagnostic samples within medical or laboratory settings. For example, the robotic assembly 100 may manipulate sensitive materials such as petri dishes containing diagnostic samples. This robotic assembly 100 may address several shortcomings of conventional laboratory equipment by offering precise control and gentle handling to prevent sample contamination and damage.

As illustrated in FIG. 1A, FIG. 1B, and FIG. 1C, the robotic assembly 100 may include a first gripping arm 103 and a second gripping arm 112. The first gripping arm 103 may be defined by a first length 106 and may include a first roller 109a. The first roller 109a may be located at a first distal end of the first gripping arm 103. As illustrated in FIG. 1A and FIG. 1B, the first gripping arm 103 may include a second roller 109b, e.g., positioned at another location along the first gripping arm 103. The first roller 109a may provide initial contact and stability when engaging with an object 118. The second roller 109b, positioned further along the first gripping arm 103, may aid in maintaining contact and control over an orientation of the object 118.

As illustrated in FIG. 1A and FIG. 1B, the second gripping arm 112 may be defined by a second length 116 that is less than the first length 106 of the first gripping arm 103. The second gripping arm 112 includes a third roller 115 that may be mounted at a first distal end of the second gripping arm 112. The second gripping arm 112 may complement the function of the first gripping arm 103 to safely secure the object 118. The second distal end of the first gripping arm may be pivotally connected about a pivot axis 113 to the second distal end of the second gripping arm 112.

The placement and function of the rollers (e.g., first roller 109a, second roller 109b, and third roller 115) on the first gripping arm 103 and the second gripping arm 112 may facilitate efficient and precise of handling object 118 (e.g., a petri dish). For example, the object 118 may be stabilized as each of the first roller 109a, positioned at the distal end of the first gripping arm 103, and the second roller 109b, located another location along the first gripping arm 103, make contact. Moreover, because the first gripping arm 103 is longer than the second gripping arm 112, the first gripping arm 103 may reach around the object 118 and provide a primary point of contact. Moreover, this configuration may be advantageous for handling objects of varying diameters, as the extended length of the first gripping arm 103 may facilitate initial engagement with the object 118, securing it from one side while preparing for complete enclosure.

Moreover, the third roller 115, positioned at the distal end of the second gripping arm 112, may complement the first two rollers (e.g., first roller 109a and second roller 109b) by securing the opposite side of the object 118. As the relative angle between the first and second gripping arms about the pivot axis 113 is reduced, the relative positioning of the rollers (e.g., first roller 109a, second roller 109b, and third roller 115) may allow the first gripping arm 103 and the second gripping arm 112 to securely clasp the object 118. The relative positioning of each of the first gripping arm 102, the second gripping arm 112, and/or the respective rollers (e.g., first roller 109a, second roller 109b, and third roller 115) may create a self-centering mechanism that aligns the object 118 along the centroidal axis as the first gripping arm 103 and the second gripping arm 112 close. As the relative angle between the first gripping arm 103 and the second gripping arm 112 decreases, the differential lengths of the first gripping arm 103 and the second gripping arm 112, combined with the precise placement of the respective rollers (e.g., first roller 109a, second roller 109b, and third roller 115), the object 118 may be secured and positioned optimally for subsequent diagnostic processing. Moreover, manual adjustments and repositioning may be minimized, significantly enhancing operational efficiency and the safety of sensitive diagnostic samples.

As illustrated in FIG. 1C, first gripping arm 103 may be pivotally connected to second gripping arm 112 via pivotal connection 110. Pivotal connection 110 may include one or more members (e.g., 2 members) or may be a single connection point between the first gripping arm 103 and the second gripping arm 112. The pivotal connection 110 may enable the first gripping arm 103 and the second gripping arm 112 to open and close. For example, as the angle of pivotal connection increases, the opening between the first gripping arm 103 and the second gripping arm 112 may increase. A larger opening may allow the first gripping arm 103 and the second gripping arm 112 to accommodate objects of various sizes between the first gripping arm 103 and the second gripping arm 112. As the angle of the pivotal connection decreases, the opening between the first gripping arm 103 and the second gripping arm 112 may decrease. The smaller angle of pivotal connection may enable the first gripping arm 103 and the second gripping arm 112 to apply pressure to an object (e.g., object 118) in order to pick up the object (e.g., object 118).

A plurality of compression springs 121a, 121b, and 121c may be employed to provide tension between the first gripping 101 arm and the second gripping arm 112. The compression springs 121a, 121b, and 121c may be configured to allow the gripping arms to move relative to each other, accommodating an object 118 of varying sizes and shapes. In some aspects the object 118 may be a petri dish. In some aspects, the compression springs 121a-121c are helical springs that are used to provide force between the first gripping arm 103 and second gripping arm 112 to grip object 118. Moreover, the plurality of compression springs 121a, 121b, and 121c may enable the first gripping arm 103 and the second gripping arm 112 to maintain a firm yet adjustable grip on objects of varying sizes and shapes (e.g., object 118), such as a petri dish. An actuator 124 (e.g., a finger actuator) may be attached to both the first gripping arm 103 and the second gripping arm 112. The actuator 124 may counteract the tension provided by the compression springs 121a-121c by modulating the distance and pressure between the first gripping arm 103 and second gripping arm 112. For example, the actuator 124 may be attached to both the first gripping arm 103 and second gripping arm 112 and may extend from a first length to a second length and vice versa. By extending from a first length to a second length, the actuator 124 may counteracts the tension from the compression springs 121a-121c, allowing for controlled gripping and release of the object 118. Moreover, the actuator 124 may facilitate a gripping process that is smooth and precise for handling diagnostic samples without compromising their integrity.

In some aspects the actuator 124 may be a finger actuator. For example, the actuator 124 may extend and retract to allow for meticulous adjustments in grip strength and positioning in order to accommodate fragile or irregularly shaped objects that require sensitive handling. Moreover, the actuator 124 may operate with a fine level of control over the compression and expansion of the first gripping arm 103 and the second gripping arm 112, facilitating a grip that is tight enough to secure the object 118 without exerting undue pressure that might cause damage. This precision may be particularly beneficial in a diagnostic setting where the integrity of a sample is paramount.

Furthermore, dynamic response of the actuator 124 to varying conditions and requirements may enhance its utility in automated diagnostic systems. By adjusting the distance between the first gripping arm 103 and the second gripping arm 112 in response to the size and required handling force of the object 118, the actuator 124 may handle each sample in an optimized manner. This adaptability may improve the efficiency of the diagnostic process and may reduce the likelihood of human error that could occur with manual handling.

In some aspects, the robotic assembly 100 may include an anti-backlash spring 127 to maintain the angular position of the first gripping arm 103 in relation to the second gripping arm 112 (e.g., when gripping object 118). Moreover, the anti-backlash spring 127 may provide consistent and reliable handling by preventing any sudden or unwanted movements during the gripping process.

In some aspects, an angle sensor 130 may determine the relative position of the first gripping arm 103 in relation to the second gripping arm 112. The angle sensor 130 may provide feedback for control purposes. The angle sensor 130 may enable the robotic assembly 100 to determine the correct angle to grip object 118 and continuously adjust the relative position of the first gripping arm 103 in relation to the second gripping arm 112. For example, the angle sensor 130 may provide feedback used by the robotic assembly 100 to optimally position the first gripping arm 103 in relation to the second gripping arm 112 for one or more specific tasks. Moreover, the feedback from the angle sensor 130 may be used for real-time orientation and/or positioning adjustments associated with the object 118.

In some aspects, a motor 133 may be incorporated to rotate the robotic arm about a second axis 136 (e.g., perpendicular to the first axis), enabling additional flexibility in object transportation and storage. This rotational capability associated with the motor 133 may facilitate maneuvering the first gripping arm 103 and the second gripping arm 112 through various spatial configurations within a diagnostic device, enabling the robotic assembly 100 to access and retrieve objects (e.g., object 118) placed in different locations.

In some aspects, a high-friction material may be used for the rollers (e.g., first roller 109a, second roller 109b, and third roller 115) to maintain a secure grip on object 118. For example, the high-friction materials may be associated with maintaining control over the samples without slipping and handling objects that require precise placement and alignment within diagnostic equipment.

In some aspects, the robotic assembly 100 may be part of a larger diagnostic device such as assembly 300, where the robotic assembly 100 may be used to move objects such as petri dishes containing diagnostic samples to various stations within the device for analysis.

When an object such as a petri dish needs to be gripped, the actuator 124 extends, may cause the first gripping arm 103 and the second gripping arm 112 to separate against the tension of the compression springs 121a-121c. This separation allows the rollers 106a-106c to accommodate the object 118, aligning along the object 118 centroidal axis. Once the object 118 is within the first gripping arm 103 and the second gripping arm 112, the actuator 124 retracts, bringing the first gripping arm 103 and the second gripping arm 112 closer together and securing the object 118 in place. The robotic assembly 100 may then move object 118 to a desired location within the diagnostic device for storage or further analysis.

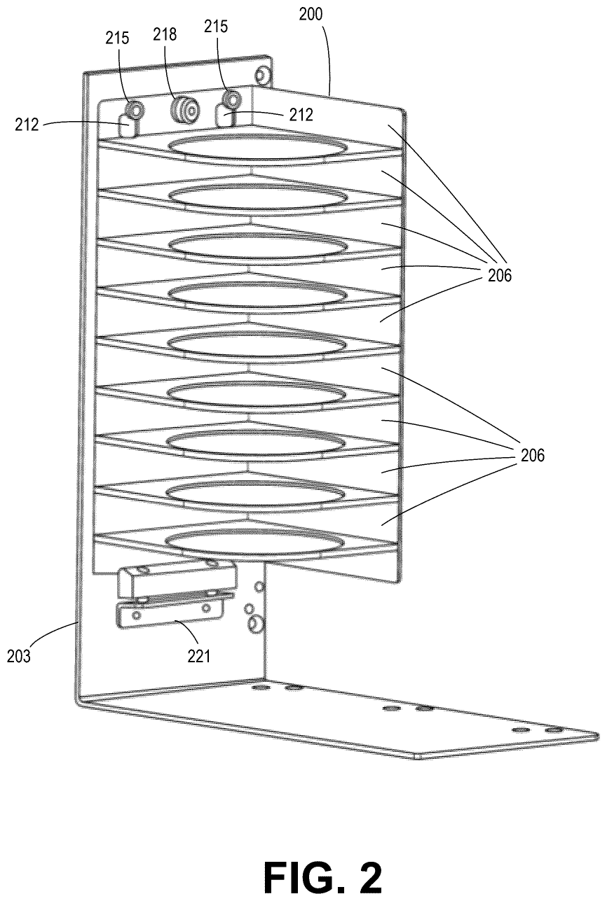

As illustrated in FIG. 2, a hotel assembly 200 may facilitate the organized storage and easy access of diagnostic samples (e.g., object 118) within a larger diagnostic device. The hotel assembly 200 may include multiple slots 206. Each slot 206 may securely house an individual object (e.g., object 118), such as a petri dish or sample container. The slots 206 may be arranged in a vertical array. For example, the vertical array of slots 206 may optimize the use of vertical space. Moreover, the vertical array of slots 206 may sequentially and systematically store multiple samples. According to some aspects, the arrangement of slots 206 may increase accessibility and organization of the samples, enhancing diagnostic processes where time and order of processing significantly impacts results.

The hotel assembly 200 may comprise a mechanical attachment system including a thumb screw 209. The thumb screw 209 may securely attach the hotel assembly 200 to a planar vertical surface 203 within the diagnostic device. For example, the thumb screw 209 may facilitate a strong, stable connection that can easily be adjusted or removed as needed, providing flexibility in the setup and maintenance of the diagnostic device's internal configuration. This attachment of the hotel assembly 200 to the planar vertical surface 203 may prevent any movement that could disrupt the samples or interfere with the diagnostic procedures, ensuring that the hotel assembly 200 remains fixed during operations.

To aid in the precise and secure installation of the hotel assembly 200, the hotel assembly 200 may include one or more alignment cavities 212. The one or more alignment cavities 212 may be strategically positioned to engage with corresponding protrusions 215 on the planar vertical surface 203. The alignment cavities 212, which may be shaped as holes or cutouts, may guide the hotel assembly 200 during attachment (e.g., to planar vertical surface 203) and/or provide positional stability once installed. Moreover, the alignment cavities 212 may maintain orientation and spacing for optimal operation by aligning correctly with other system components.

According to some aspects, the protrusions 215 on the planar vertical surface 203 may interact with the alignment cavities 212. Each protrusion 215 may include an inner portion (e.g., cylindrical) and an outer portion (e.g., cylindrical), where the inner portion has a smaller width or diameter compared to the outer portion. For example, the protrusions 215 may be spools. The alignment cavities 212 may allow the outer portion of the protrusions 215 to pass through a first portion of the alignment cavity 212, while the second portion of the alignment cavity 212 is sized to accommodate the inner portion without allowing the passage of the outer portion. The configuration of the alignment cavities 212 and the protrusions 215 may effectively lock the hotel assembly 200 in place, providing a secure and reliable connection that resists accidental dislodging. Moreover, the thumb screw 209 may allow for manual adjustment and tightening, such that the hotel assembly 200 is not only aligned but also tightly secured against any mechanical shocks or vibrations that might occur during the operation of the diagnostic device.

According to some aspects, the hotel assembly 200 may include a spring latch 221 to secure the hotel assembly 200 to the planar vertical surface 203. The spring latch 221 may be incorporated at the bottom of the hotel assembly 200 and engage with the planar vertical surface 203. The spring latch 221 may provide an extra layer of security, preventing the lower part of the hotel assembly 200 from detaching or swinging, thereby maintaining the overall stability and integrity of the hotel assembly 200. For example, in high-throughput environments where the hotel assembly 200 is subjected to frequent use and mechanical interaction, the spring latch 221 may provide robust and reliable construction to maintain operational precision and sample integrity.

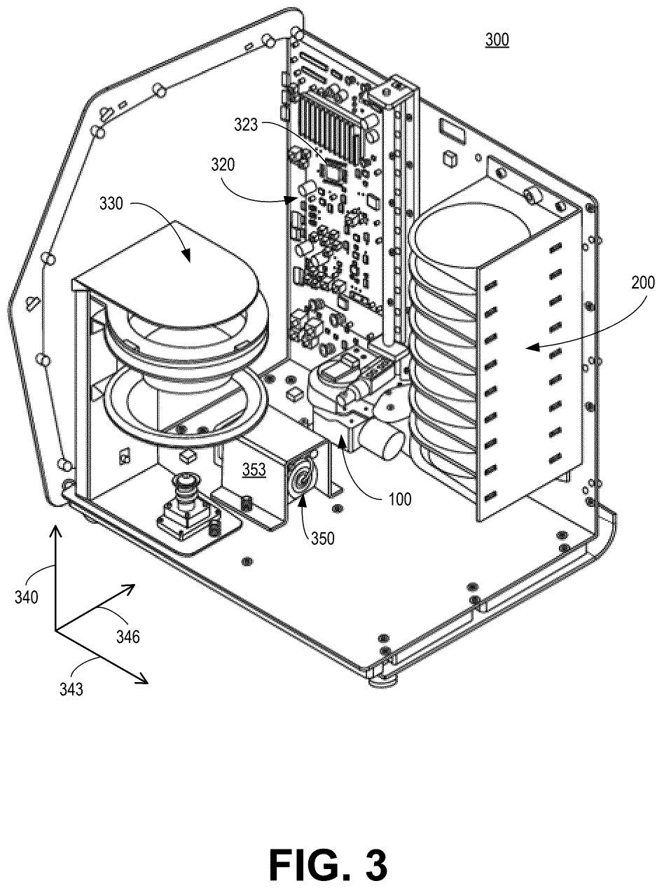

As illustrated in FIG. 3, diagnostic system 300 may include the robotic assembly 100 and the hotel assembly 200. For example, the diagnostic system 300 and/or the robotic assembly 100 may be mounted on a horizontal surface or a vertical surface of the diagnostic system 300. Moreover, strategic placement of the hotel assembly 200 may provide the robotic assembly 100 with efficient access to and from the hotel assembly 200, thereby optimizing workflow and minimizing movement required to transfer samples. The proximity of the robotic assembly 100 and the hotel assembly 200 may facilitate interaction between storage and handling functions to maintain the integrity and order of the samples throughout the diagnostic process.

According to some aspects, the diagnostic system 300 may include a printed circuit board (PCB) assembly 320. The PCB assembly 320 may include a controller 323 that is in electronic communication with various components of diagnostic system 300. This controller 323 may orchestrate various functions of the system components, including timing execution of movement and operations of the robotic assembly 100. Moreover, the controller 323 may be in electronic communication with the angle sensor 130 of the robotic assembly 100. The angle sensor 130 may provide the controller 323 with feedback associated with the position and orientation of the first gripping arm 103 and the second gripping arm 112. The feedback may allow the controller 323 to adjust the movements of the robotic assembly 100 to accurately and precisely handle the samples (e.g., object 118).

According to some aspects, diagnostic system 300 may include an optical unit 330. The optical unit 330 may be associated with analyzing diagnostic samples (e.g., within object 118). The diagnostic system 300 may be positioned to interact with the robotic assembly 100. The robotic assembly 100 may transport the samples from the hotel assembly 200 into the field of view of the optical unit 330. For example, the robotic assembly 100 may move along the z-axis 340 to access the different slots 206 of hotel assembly 200. Once an object 118 is gripped within hotel assembly 200 by the robotic assembly 100, the robotic assembly 100 can rotate (e.g., along the directions of x-axis 343 and y-axis 346) about the z-axis 340 to remove object 118 from the slot 206. The robotic assembly 100 may then move down the z axis 340 to be at the same level at optical unit 330. The robotic assembly 100 may then rotate (e.g., along the directions of x-axis 343 and y-axis 346) about the z-axis 340 to place object 118 in view of optical unit 330.

The robotic assembly 100 may be facilitated by a drive mechanism controlled by the controller 323. The drive mechanism adjusts the height and position of the robotic assembly 100. As the robotic assembly 100 moves vertically along the z-axis, it may access samples stored at different levels within the hotel assembly 200. Once the robotic arm selects a sample, it can lift it from its slot and adjust its position vertically to align it with the focal plane of the optical unit 330. Additionally, the controller 323 may recognize and adjust to specific requirements of different types of samples. For example, some samples may need to be positioned closer to sensors of the optical unit 330 for micro-level analysis, while other samples may require a broader field of view. According to some aspects, the diagnostic system 300 may include a thermal fan 350. The thermal fan 350 may include a cover 353 to protect the thermal fan 350 from the moving components within diagnostic system 300. The thermal fan 350 may be associated with regulating the temperature within the diagnostic system 300. For example, the controller 323 may control the thermal fan 350 to incubate diagnostic samples that are stored within hotel assembly 200. Moreover, the controller 323 may manage the thermal fan 350 to maintain one or more temperature settings tailored to the needs of various diagnostic stages and sample types. For instance, during incubation periods, the controller 323 may alter the fan speed for temperature-sensitive processes, such as increasing or decreasing the fan speed to lower or raise the temperature to a set point conducive for cultivating biological cultures or conducting enzymatic reactions. This temperature control may maintain the quality and reliability of the diagnostic data collected by facilitating optimal growth conditions and reaction outcomes.

For periods where samples are being held or stored, the controller 323 may increase or decrease the fan speed to allow the temperature within the diagnostic system 300 to rise or fall to a level that preserves sample integrity without unnecessarily accelerating any biological processes and preventing the degradation of sample components. Furthermore, the ability of the diagnostic system 300 to maintain different temperatures for storage and incubation may support a broad range of diagnostic applications. Moreover, the controller 323 may modulate the speed of the thermal fan 350 based on real-time feedback from internal temperature sensors. By continuously optimizing the environmental conditions, the diagnostic system 300 may respond to any deviations from the desired temperature settings, thereby maintaining a stable internal environment even under varying external conditions or operational demands.

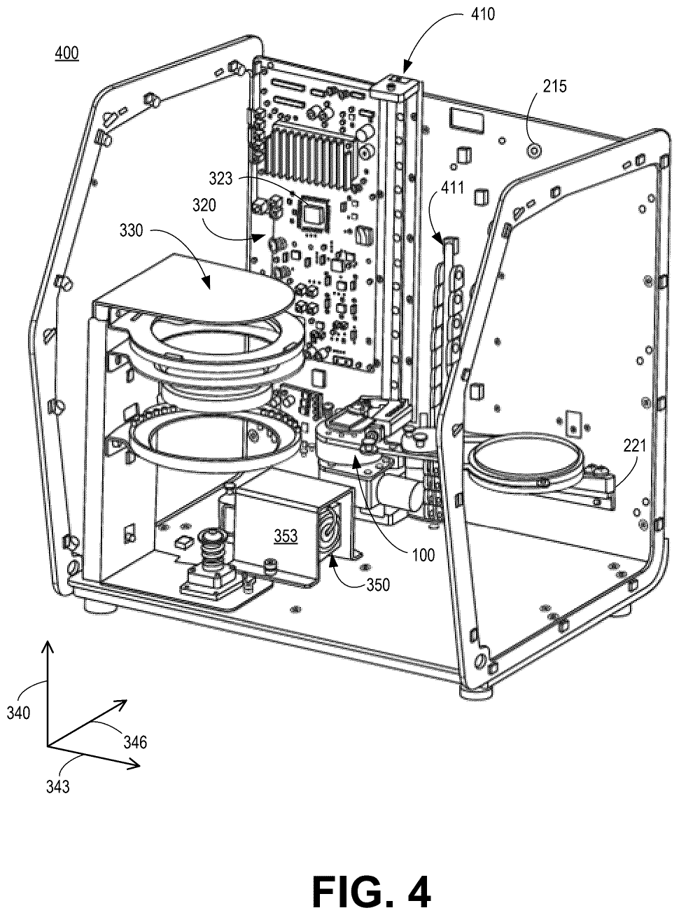

FIG. 4 illustrates a diagnostic system 400 including one or more of the robotic assembly 100, the spring latch 221, the PCB assembly 320, the controller 323, the thermal fan 350. As shown in FIG. 4, an interior of a vertical planar surface of diagnostic system 400 may include a spring latch 201, e.g., used as a retainer for hotel assembly 200. Furthermore, a vertical surface of the diagnostic system 400 may include one or more protrusions 215 (e.g., spools).

According to some aspects, the thermal fan 350 may include a cover 353 to protect the thermal fan 350 from the moving components within diagnostic system 400. The thermal fan 350 may be attached to a base of the diagnostic system 400 (e.g., via one or more screws). The cover can also be attached to the base of the diagnostic system 400 via one or more screws. According to some aspects, optical unit 330 may be attached to diagnostic system 400 adjacent to thermal fan 350. Optical unit 330 may be positioned at a relatively higher vertical position than thermal fan 350. Robotic assembly 100 may rotate about the z-axis 340. For example, robotic assembly 100 may place object 118 in view of optical unit 330.

According to some aspects, the robotic assembly 100 may utilize an e-chain 410 and gantry 411 to change vertical position (e.g., up and down in the direction of the z-axis 340) within the diagnostic system 400. The e-chain 410 may include a flexible, chain-like structure made of interconnected links that may house and protect one or more of cables, hoses, and wires associated with the robotic assembly 100. The e-chain 410 may prevent tangling, abrasion, and damage, thereby providing a safe and organized way to manage the movement of robotic assembly 100 and associated components. The e-chain 410 may move in a vertical direction (e.g., along the z-axis 340), guiding and protecting the cables associated with the robotic assembly 100 as it moves. Moreover, the e-chain 410 may maintain the integrity of the cables, e.g., ensuring the cables remain operational over time.

As illustrated in FIG. 4, the gantry 411 may include a structure spanning a portion of the diagnostic system 400. For example, the gantry 411 may span a vertical portion of an interior surface of the diagnostic system 400. The gantry 411 may support equipment such as robotic assembly 100. Moreover, the gantry 411 may include two upright beams and a horizontal beam connecting the two upright beams. The gantry 411 may provide a stable framework for robotic assembly 100 to move in a vertical direction (e.g., along the z-axis 340).

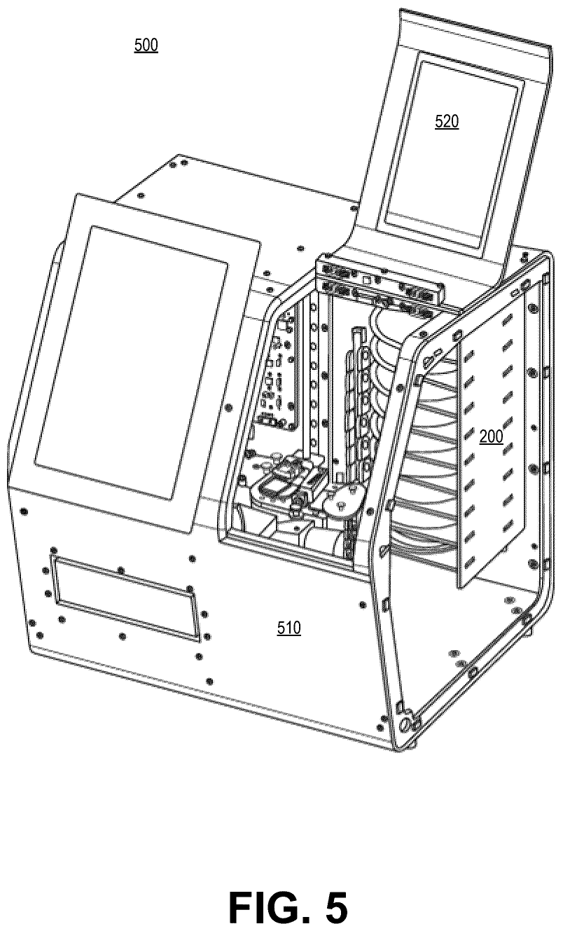

An exterior of diagnostic system 500, as illustrated in FIG. 5, may provide a functional and user-friendly interface to facilitate seamless interaction between the system and its operators. As illustrated in FIG. 5, diagnostic system 500 may include a wrapper 510. The wrapper 510, which may encase the entirety or a portion of diagnostic system 500, may be durable and resistant to harsh conditions often found in laboratory environments. For example, the wrapper 510 may be formed or constructed of a variety of materials including but not limited to plastic, metal, composite materials, silicone, or stainless steel.

The diagnostic system 500 may include a door 520. The door 520 may include a window. For example, the window may enable a user to see the interior of the diagnostic system 500 when the door 520 is closed. Moreover, sterility and temperature conditions within the diagnostic system 500 may be maintained by allowing the user to visually monitor the internal operations of the diagnostic system 500 without the need to open the door 520. Furthermore, the window may allow the user to view the object 118 within the hotel assembly 200. For example, the user may check on the status of samples housed within the hotel assembly 200.

According to some aspects, the window in the door 520 may enhance safety associated with operation of the diagnostic system 500. By providing a clear view of the interior, the door 520 may allow a user to see that the robotic assembly 100 is not in operation before opening the door 520, thus avoiding potential accidents. The window may also permit a user to conduct preliminary visual inspection of samples and their placement within the hotel assembly 200, enabling quick identification of any irregularities or issues that might require immediate attention (a misalignment or an unsealed petri dish lid).

According to some aspects, the door 520 may provide access to the interior of the diagnostic system 500, facilitating insertion or retrieval of samples to and from the hotel assembly 200. For example, a user may need to insert or retrieve samples to or from the hotel assembly 200 during busy periods in the laboratory when time and efficiency are of the essence. Moreover, one or more handles, latches, locks, hinges, etc. associated with the door 520 may allow the door 520 to be securely closed to maintain necessary environmental conditions within the diagnostic system 500. For example, a door handle and hinge mechanisms may provide smooth operation, minimizing any risk of jarring or shaking the diagnostic system 500, which could disrupt the samples or the precise calibrations of the internal components.

Before turning to the process flow diagrams of FIG. 11, it is noted that embodiments described herein may be practiced using an alternative order of the steps illustrated in FIG. 11. That is, the process flows illustrated in FIG. 11 are provided as examples only, and the embodiments may be practiced using process flows that differ from those illustrated. Additionally, it is noted that not all steps are required in every embodiment. In other words, one or more of the steps may be omitted or replaced, without departing from the spirit and scope of the embodiments. Further, steps may be performed in different orders, in parallel with one another, or omitted entirely, and/or certain additional steps may be performed without departing from the scope of the embodiments.

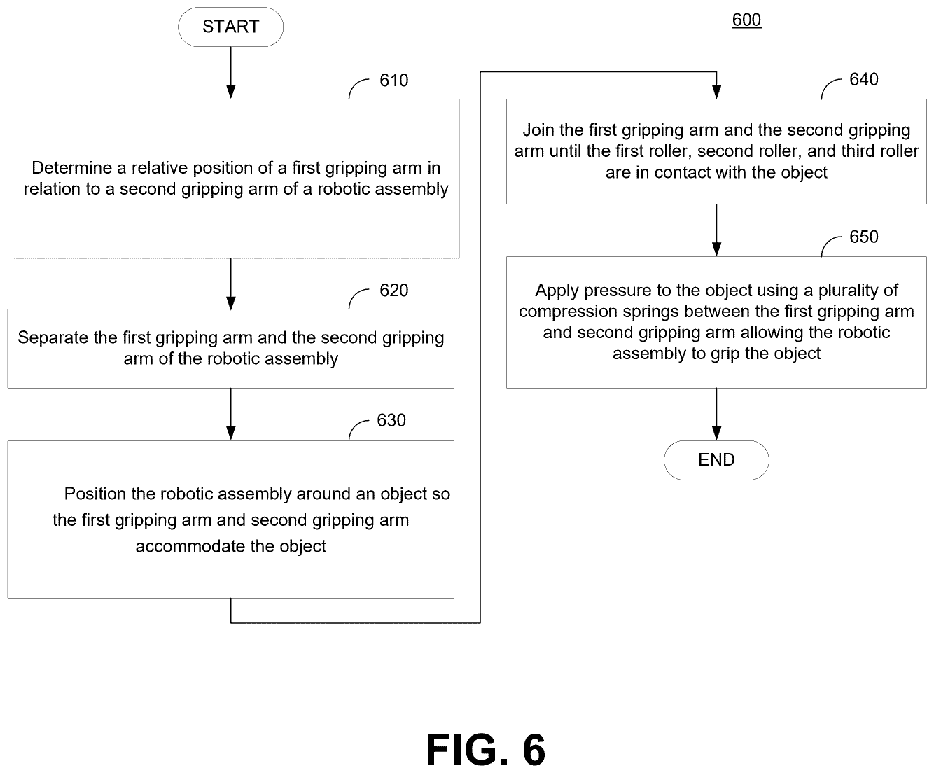

With reference to FIG. 6, shown is a flow chart of a process 600 according to various aspects of the present disclosure. The process 600 may be enacted by the robotic assembly 100, as configured in various aspects detailed throughout the disclosure. The process 600 may include advanced mechanisms and interactions among the respective diagnostic system components, ensuring precise manipulation and secure handling of sensitive diagnostic objects such as petri dishes.

At box 610, the process 600 may determine a relative position of first gripping arm 103 in relation to second gripping arm 112 of robotic assembly 100. The relative position may be determined using angle sensor 130. The angle sensor 130 may determine the proper distance required between the first gripping arm 103 in relation to the second gripping arm 112 to accommodate object 118.

For example, when the robotic assembly 100 initiates a gripping action, the angle sensor 130 may provide real-time data on the relative angular positions of the first gripping arm 103 and the second gripping arm 112. The distance between the first gripping arm 103 and the second gripping arm 112 may be adjusted based on the relative angular positions. The angle sensor 130 may monitor the current angle as the first gripping arm 103 and the second gripping arm 112 open or close around the object 118. The data from the angle sensor 130 may continuously relayed to the controller 323, which may interpret the readings to adjust the operation of the actuator 124.

At box 620, the process 600 may separate the first gripping arm 103 and the second gripping arm 112. The first gripping arm 103 and the second gripping arm 112 may be separated using actuator 124 based on the angle determined by angle sensor 130. Separating the first gripping arm 103 and the second gripping arm 112 may create space between the first gripping arm 103 and the second gripping arm 112. to position or remove the object 118 safely. The actuator 124 may extend from a first length to a second length, allowing for a versatile adjustment range and accommodating objects of differing dimensions, thereby enhancing the utility of the robotic assembly 100 across a broad spectrum of diagnostic applications.

At box 630, the process 600 may position the robotic assembly 100 around an object (e.g., object 118) so the first gripping arm 103 and second gripping arm 112 can accommodate an object 118. For example, the actuator 124 may respond to commands of the controller 323 based on the feedback from the angle sensor 130. For example, if the angle sensor 130 indicates that the angle is too wide, suggesting that the first gripping arm 103 and the second gripping arm 112 are too far apart to secure the object 118 effectively, the actuator 124 may contract, bringing the first gripping arm 103 and the second gripping arm 112 closer together. If the angle is too narrow, the actuator 124 may extend, increasing the distance between the first gripping arm 103 and the second gripping arm 112 to prevent excessive pressure on the object 118, which could lead to damage or improper handling.

At box 640, the process 600 may join the first gripping arm 103 and the second gripping arm 112 until the first roller 109a, the second roller 109b, and the third roller 115 are in contact with object 118. The actuator 124 may retract, drawing the first gripping arm 103 and the second gripping arm 112 closer until the rollers (first roller 109a, second roller 109b, and third roller 115) make contact with the object 118. This contact may be managed to ensure a secure grip without exerting excessive pressure that could compromise the sample integrity. The rollers, comprising high-friction material, may engage the object 118 at positions calculated to distribute the gripping force evenly, aligning with a centroidal axis of the object 118 for balanced handling.

The dynamic adjustment process may maintain the integrity of diagnostic samples by holding them securely without undue pressure. Moreover, precise control of the first gripping arm 103 and the second gripping arm 112 facilitated by data received from the angle sensor 130 may be used to handle each sample in a manner that preserves its viability for subsequent analysis. Moreover, using angular feedback from the angle sensor 130 to adjust the distance between the first gripping arm 103 and the second gripping arm 112 may allow the robotic assembly 100 to adapt to various sizes and shapes of objects, enhancing the flexibility and utility of the diagnostic system in a laboratory setting.

At box 650, the process 600 may apply pressure to object 118 using compression springs 121a-121c that are between the first gripping arm 103 and second gripping arm 112 allowing the robotic assembly 100 to grip object 118. The compression springs may be specifically selected for their force characteristics, provide a consistent tension that aids in holding the object 118 securely during transportation to various diagnostic stations. Moreover, the calibrated pressure may allow the robotic assembly 100 to perform controlled release or gripping actions to handle fragile diagnostic samples that require meticulous care to prevent contamination and ensure accurate test results.

The robotic assembly described herein offers a versatile and effective solution for gripping and manipulating petri dishes containing diagnostic samples within a diagnostic device. Its unique design features, including the use of compression springs, an actuator, and multiple rollers, enable it to handle petri dishes with ease and precision, facilitating efficient and reliable sample processing in automated diagnostic systems.

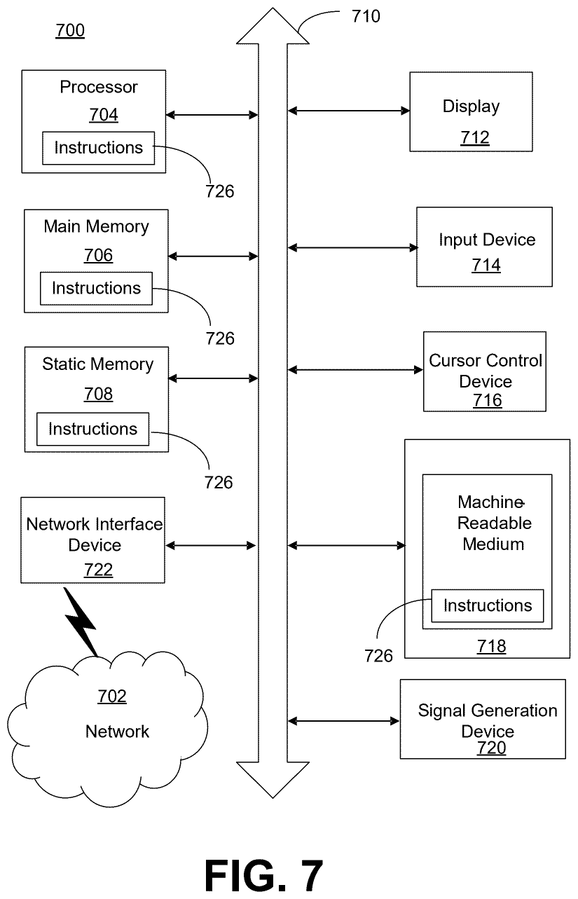

FIG. 7 depicts an exemplary diagrammatic representation of a machine in the form of a computer system 700 within which a set of instructions, when executed, may cause the machine to perform any one or more of the methods described above. One or more instances of the machine can operate, for example, as computing device 800, processor 802, controller 323, and other devices of FIGS. 1-6 and 8. In some examples, the machine may be connected (e.g., using a network 702) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 700 may include a processor (or controller) 704 (e.g., a central processing unit (CPU)), a graphics processing unit (GPU, or both), a main memory 706 and a static memory 708, which communicate with each other via a bus 710. The computer system 700 may further include a display unit 712 (e.g., a liquid crystal display (LCD), a flat panel, or a solid-state display). Computer system 700 may include an input device 714 (e.g., a keyboard), a cursor control device 716 (e.g., a mouse), a disk drive unit 718, a signal generation device 720 (e.g., a speaker or remote control) and a network interface device 722. In distributed environments, the examples described in the subject disclosure can be adapted to utilize multiple display units 712 controlled by two or more computer systems 700. In this configuration, presentations described by the subject disclosure may in part be shown in a first of display units 712, while the remaining portion is presented in a second of display units 712.

The disk drive unit 718 may include a tangible computer-readable storage medium on which is stored one or more sets of instructions (e.g., instructions 726) embodying any one or more of the methods or functions described herein, including those methods illustrated above. Instructions 726 may also reside, completely or at least partially, within main memory 706, static memory 708, or within processor 704 during execution thereof by the computer system 700. Main memory 706 and processor 704 also may constitute tangible computer-readable storage media.

While examples of a system for handling and transporting diagnostic samples have been described in connection with various computing devices/processors, the underlying concepts may be applied to any computing device, processor, or system capable of handling and transporting diagnostic samples. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer readable storage medium is not a propagating signal. A computer-readable storage medium as described herein is an article of manufacture. When the program code is loaded into and executed by a machine, such as a computer, the machine becomes a device for handling and transporting diagnostic samples. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with handling and transporting diagnostic samples as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an erasable programmable read-only memory (EPROM), a gate array, a programmable logic device (PLD), a client computer, or the like, the machine becomes a device for implementing diagnostic testing as described herein. When implemented on a general-purpose processor, the program code combines with the processor to provide a unique device that operates to invoke the functionality of handling and transporting diagnostic samples.

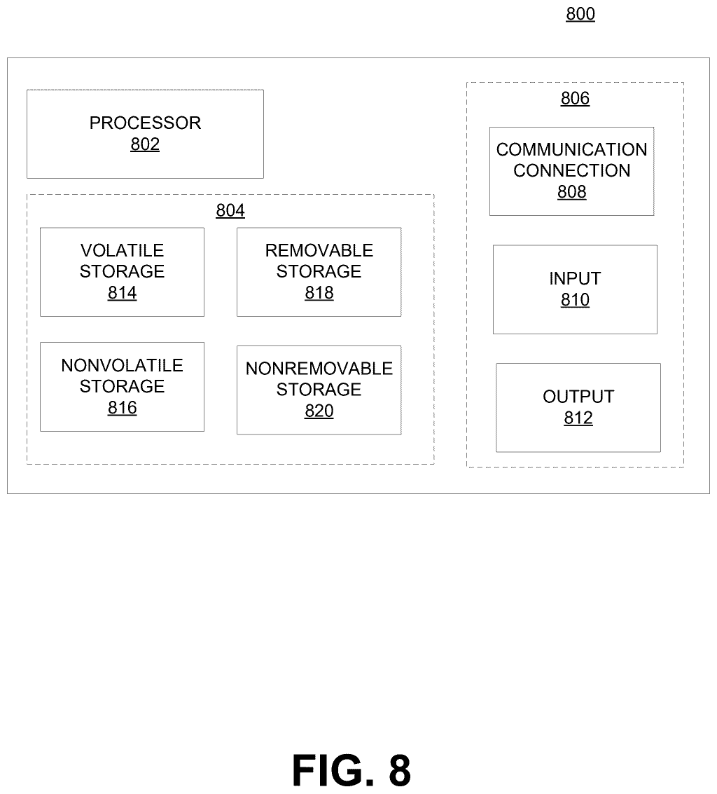

FIG. 8 is a block diagram of a computing device 800 that may be connected to or comprise a component of one or more devices of FIGS. 1-7. Computing device 800 may comprise hardware or a combination of hardware and software. The functionality to handle and transport diagnostic samples may reside in one or a combination of computing devices 800. Computing device 800 depicted in FIG. 8 may represent or perform functionality of an appropriate computing device 800, or a combination of computing devices 800, such as, for example, a component or various components of a diagnostic system, a computing device, a processor, a server, a gateway, a database, a firewall, a router, a switch, a modem, an encryption tool, a virtual private network (VPN), a network access control (NAC) device, a secure web gateway, or the like, or any appropriate combination thereof. It is emphasized that the block diagram depicted in FIG. 8 is exemplary and not intended to imply a limitation to a specific example or configuration. Thus, computing device 800 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Computing device 800 may comprise a processor 802 and a memory 804 coupled to processor 802. Memory 804 may contain executable instructions that, when executed by processor 802, cause processor 802 to effectuate operations associated with a diagnostic system. As evident from the description herein, computing device 800 is not to be construed as software per se.

In addition to processor 802 and memory 804, computing device 800 may include an input/output system 806. Processor 802, memory 804, and input/output system 806 may be coupled together (coupling not shown in FIG. 8) to allow communications between them. Each portion of computing device 800 may comprise circuitry for performing functions associated with each respective portion. Thus, each portion may comprise hardware, or a combination of hardware and software. Accordingly, each portion of computing device 800 is not to be construed as software per se. Input/output system 806 may be capable of receiving or providing information from or to a communications device or other network entities configured for handling and transporting diagnostic samples. For example, input/output system 806 may include a wireless communication (e.g., 3G/4G/5G/GPS) card. Input/output system 806 may be capable of receiving or sending video information, audio information, control information, image information, data, or any combination thereof. Input/output system 806 may be capable of transferring information with computing device 800. In various configurations, input/output system 806 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 806 may comprise a Wi-Fi finder, a two-way GPS chipset or equivalent, or the like, or a combination thereof.

Input/output system 806 of computing device 800 also may contain a communication connection 808 that allows computing device 800 to communicate with other devices, network entities, or the like. Communication connection 808 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 806 also may include an input device 810 such as keyboard, mouse, pen, voice input device, or touch input device. Input/output system 806 may also include an output device 812, such as a display, speakers, or a printer.

Processor 802 may be capable of performing functions associated with a diagnostic system, such as functions for handling and transporting diagnostic samples, as described herein. For example, processor 802 may be capable of, in conjunction with any other portion of computing device 800, gripping and manipulating petri dishes containing diagnostic samples within a diagnostic device, as described herein.

Memory 804 of computing device 800 may comprise a storage medium having a concrete, tangible, physical structure. As is known, a signal does not have a concrete, tangible, physical structure. Memory 804, as well as any computer-readable storage medium described herein, is not to be construed as a signal. Memory 804, as well as any computer-readable storage medium described herein, is not to be construed as a transient signal. Memory 804, as well as any computer-readable storage medium described herein, is not to be construed as a propagating signal. Memory 804, as well as any computer-readable storage medium described herein, is to be construed as an article of manufacture.

Memory 804 may store any information utilized in conjunction with diagnostic testing. Depending upon the exact configuration or type of processor, memory 804 may include a volatile storage 814 (such as some types of RAM), a nonvolatile storage 816 (such as ROM, flash memory), or a combination thereof. Memory 804 may include additional storage (e.g., a removable storage 818 or a non-removable storage 820) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by computing device 800. Memory 804 may comprise executable instructions that, when executed by processor 802, cause processor 802 to effectuate operations associated with diagnostic testing.

While the disclosed systems have been described in connection with the various examples of the various figures, it is to be understood that other similar implementations may be used, or modifications and additions may be made to the described examples of a diagnostic system without deviating therefrom. For example, one skilled in the art will recognize that a diagnostic system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—handling and transporting diagnostic samples—as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

What is claimed is:

1. A robotic arm associated with gripping an object, the robotic arm comprising:
a first gripping arm defined by a first length, comprising a first roller located at a first distal end of the first gripping arm, and comprising a second roller positioned at another location along the first gripping arm;
a second gripping arm defined by a second length that is less than the first length of the first gripping arm, and comprising a third roller mounted at a first distal end of the second gripping arm, wherein a second distal end of the first gripping arm is pivotally connected about a first axis to a second distal end of the second gripping arm;
a plurality of compression springs, wherein the plurality of compression springs is associated with providing tension between the first gripping arm and the second gripping arm; and
an actuator attached to the first gripping arm and to the second gripping arm, wherein the actuator is associated with counteracting the tension provided by the compression springs by extending from a first length to a second length.

2. The robotic arm of claim 1, wherein the first gripping arm and the second gripping arm separate to accommodate the object when the actuator extends to the second length.

3. The robotic arm of claim 1, wherein the actuator is a linear actuator configured to extend linearly between the first and second lengths.

4. The robotic arm of claim 1, further comprising an anti-backlash spring, wherein the anti-backlash spring maintains an angular position of the first gripping arm in relation to the second gripping arm when the robotic arm grips the object.

5. The robotic arm of claim 1, further comprising an angle sensor, wherein the angle sensor determines a relative position of the first gripping arm in relation to the second gripping arm.

6. The robotic arm of claim 1, further comprising a motor, wherein the motor rotates the robotic arm about a second axis perpendicular to the first axis.

7. The robotic arm of claim 1, further comprising:
an angle sensor, wherein the angle sensor determines a relative position of the first gripping arm in relation to the second gripping arm;
a motor, wherein the motor rotates the robotic arm about a second axis perpendicular to the first axis; and
a controller in electronic communication with the angle sensor and the motor, wherein the controller synchronizes movement of the robotic arm based on inputs from the angle sensor and control signals to the motor.

8. The robotic arm of claim 1, wherein each of the first roller, the second roller, and the third roller contact the object based on the tension provided by the plurality of compression springs.

9. The robotic arm of claim 1, wherein the first roller, the second roller, and the third roller are positioned to align with a centroidal axis of the object when gripped.

10. The robotic arm of claim 1, wherein the compression springs are helical springs and provide a force sufficient to grip the object.

11. The robotic arm of claim 1, wherein each of the first roller, the second roller, and the third roller comprise high-friction material.

12. An apparatus comprising:
a container comprising a plurality of slots, wherein each slot is defined by dimensions associated with an object; and
a robotic arm associated with moving an object into a slot of the plurality of slots, the robotic arm comprising:
a first gripping arm defined by a first length, comprising a first roller located at a first distal end of the first gripping arm, and comprising a second roller positioned at another location along the first gripping arm;
a second gripping arm defined by a second length that is less than the first length of the first gripping arm, and comprising a third roller mounted at a first distal end of the second gripping arm, wherein a second distal end of the first gripping arm is pivotally connected about a first axis to a second distal end of the second gripping arm;
a plurality of compression springs, wherein the plurality of compression springs is associated with providing tension between the first gripping arm and the second gripping arm; and
an actuator attached to the first gripping arm and to the second gripping arm, wherein the actuator is associated with counteracting the tension provided by the compression springs by extending from a first length to a second length.

13. The apparatus of claim 12, wherein the first gripping arm and the second gripping arm separate to accommodate the object when the actuator extends to the second length.

14. The apparatus of claim 12, wherein the actuator is a linear actuator configured to extend linearly between the first and second lengths.

15. The apparatus of claim 12, further comprising an anti-backlash spring, wherein the anti-backlash spring maintains an angular a relative position of the first gripping arm in relation to the second gripping arm when the robotic arm grips the object.

16. The apparatus of claim 12, further comprising an angle sensor, wherein the angle sensor determines a relative position of the first gripping arm in relation to the second gripping arm.

17. The apparatus of claim 12, further comprising a motor, wherein the motor rotates the robotic arm about a second axis parallel to the first axis.

18. The apparatus of claim 12, further comprising:
an angle sensor, wherein the angle sensor determines a relative position of the first gripping arm in relation to the second gripping arm;
a motor, wherein the motor rotates the robotic arm about a second axis parallel to the first axis; and
a controller in electronic communication with the angle sensor and the motor, wherein the controller synchronizes movement of the robotic arm based on inputs from the angle sensor and control signals to the motor.

19. An apparatus comprising:
a drawer associated with receiving and supporting an object;
a container comprising a plurality of slots, wherein each slot is defined by dimensions associated with the object; and
a robotic arm associated with moving the object from the drawer to a slot of the plurality of slots, the robotic arm comprising:
a first gripping arm defined by a first length, comprising a first roller located at a first distal end of the first gripping arm, and comprising a second roller positioned at another location along the first gripping arm;
a second gripping arm defined by a second length that is less than the first length of the first gripping arm, and comprising a third roller mounted at a first distal end of the second gripping arm, wherein a second distal end of the first gripping arm is pivotally connected about a first axis to a second distal end of the second gripping arm;
a plurality of compression springs, wherein the plurality of compression springs is associated with providing tension between the first gripping arm and the second gripping arm; and
an actuator attached to the first gripping arm and to the second gripping arm, wherein the actuator is associated with counteracting the tension provided by the compression springs by extending from a first length to a second length.

20. The apparatus of claim 19, further comprising a motor, wherein the motor rotates the robotic arm about a second axis perpendicular to the first axis.
